(19) United States
(12) Patent Application Publication
(10) Pub. No.: US 2012/0195518 A1
(43) Pub. Date: Aug. 2, 2012

(54) IMAGE COMPENSATION METHOD AND SYSTEM

(75) Inventors: TAI-HUNG CHEN, TAIPEI (TW); YI-WEN TSAI, TAIPEI (TW); YI-JIAN LEE, TAIPEI (TW)

(73) Assignee: ABILITY ENTERPRISE CO., LTD., TAIPEI (TW)

(21) Appl. No.: 13/216,668

(22) Filed: Aug. 24, 2011

(30) Foreign Application Priority Data
Jan. 28, 2011 (TW) 100103250

(51) Int. Cl. G06K 9/40

(52) U.S. Cl. 382/254

(57) ABSTRACT

The present invention is directed to an image compensation method and system. A first frame of a plurality of first pixels is provided. A compensation step is performed on the first pixels to generate a second frame of a plurality of second pixels, wherein any two of the adjacent second pixels have a same distance therebetween. A frame resizing step is performed before and/or after the compensation step.

### CROSS-REFERENCE TO RELATED APPLICATIONS

The entire contents of Taiwan Patent Application No. 100103250, filed on Jan. 28, 2011, from which this application claims priority, are incorporated herein by reference.

### BACKGROUND OF THE INVENTION

1. Field of the Invention

The present invention generally relates to an imaging device, and more particularly to an image compensation method and system for image distortion.

2. Description of Related Art

A lens system is one of the important elements of a camera, and is made of one or more lenses that collect and deflect incident light to be focused on an image sensor. The lens itself incurs image distortion. Considering camera volume, weight or manufacturing cost, the camera lens may be liable to more serious image distortion. Barrel distortion and pincushion distortion are common lens induced image distortion. In an image affected by the barrel distortion, the more distance the pixel is away from a center point, the lesser is its image magnification. In an image affected by the pincushion distortion, the more distance the pixel is away from a center point, the larger is its image magnification. The center point mentioned above commonly corresponds to the optical axis of the lens.

Moreover, even the same type of lens may result in different type and amount of image distortion when the lens is collocated with different image sensor or hardware circuit. This situation makes the collocation of the lens and the image sensor inflexible for the manufacturer.

A distortion compensation technique need be applied to correct the image when the amount of distortion is great enough. The distortion compensation technique is conventionally performed on the pixels by shift computation along four directions, that is, positive X direction, negative X direction, positive Y direction and negative Y direction. The computation amount is so immense such that a real-time implementation is not realizable, processing resource is wasted and a great amount of memory space is required. Accordingly, the conventional compensation technique is not appropriate to a modern camera that demands low volume, light weight and low cost.

For the foregoing reasons, a need has arisen to propose a novel image compensation scheme to solve the problems encountered in conventionally manufacturing the cameras.

### SUMMARY OF THE INVENTION

In view of the foregoing, it is an object of the embodiment of the present invention to provide an image compensation method and system to compensate for the lens induced image distortion, such that the distortion compensation technique may be substantially simplified and the collocation of the lens and other composing elements may become flexible.

According to one embodiment of the present invention, a first frame of a plurality of first pixels is provided. A compensation step is performed on the first pixels to generate a second frame of a plurality of second pixels, wherein any two of the adjacent second pixels have a same distance therebetween. A frame resizing step is performed before and/or after the compensation step.

According to another embodiment of the present invention, an image compensation system includes an image capturing module, an operating unit and an alteration unit. The image capturing module is configured to provide a first frame having a plurality of first pixels and a base point. The operating unit is configured to perform a compensation step on the first pixels to generate a second frame of a plurality of second pixels, wherein, any two of the adjacent second pixels have a same distance therebetween, and a shift operation is executed on the first pixels along a compensation direction based on the base point. The alteration unit is configured to perform a frame resizing step before and/or after the compensation step.

### BRIEF DESCRIPTION OF THE DRAWINGS

FIG. 1A shows a block diagram of an image compensation system according to one embodiment of the present invention;

FIG. 1B exemplifies a first frame and a second frame of barrel distortion;

FIG. 2A shows a block diagram of an image compensation system according to another embodiment of the present invention;

FIG. 2B exemplifies the first frame and the second frame of barrel distortion;

FIG. 3 shows a block diagram of an image compensation system according to a further embodiment of the present invention;

FIG. 4A shows a detailed block diagram of the alteration unit;

FIG. 4B shows another detailed block diagram of the alteration unit;

FIG. 4C shows a further detailed, block diagram of the alteration unit;

FIG. 5A shows a flow diagram of an image compensation method according to one embodiment of the present invention;

FIG. 5B shows a flow diagram of an image compensation method according to another embodiment of the present invention;

FIG. 5C shows a flow diagram of an image compensation method according to a further embodiment of the present invention;

FIG. 6A shows a cutting step performed before the frame resizing step;

FIG. 6B shows a cutting step performed after the frame resizing step;

FIG. 6C shows two cutting steps performed respectively before and after the frame resizing step; and

FIG. 7 shows raw pixels and an interpolated pixel.

### DETAILED DESCRIPTION OF THE INVENTION

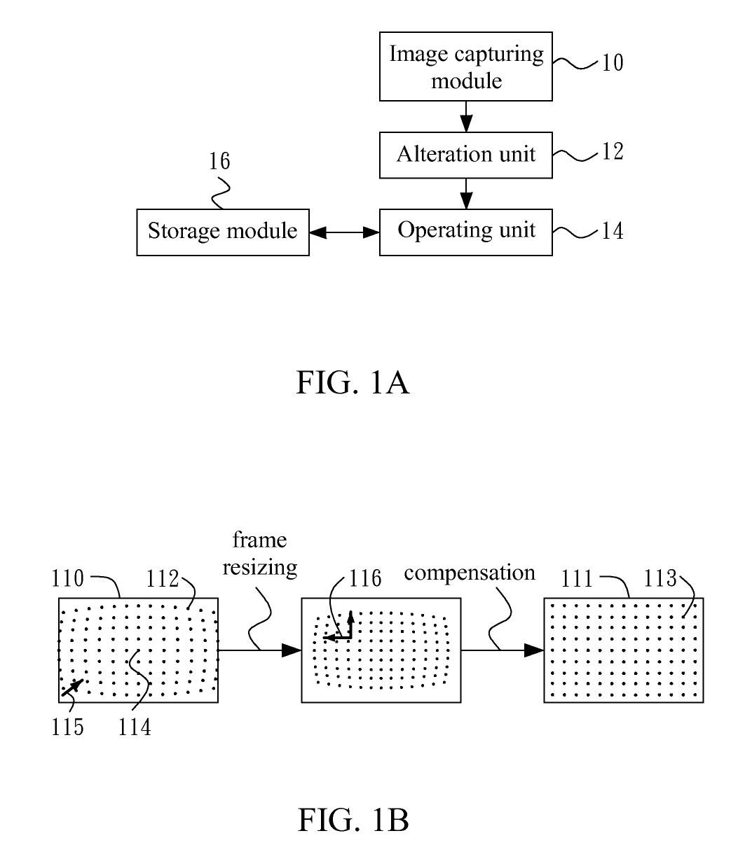

FIG. 1A shows a block diagram of an image compensation system according to one embodiment of the present invention. The image compensation system may be adapted to an imaging device such as, but not limited to, a camera, a video recorder, a mobile phone, a personal digital assistant, a digital music player or a webcam. In the embodiment, the image compensation system primarily includes an image capturing module 10, an alteration unit 12, an operating unit 14 and a storage module 16.

FIG. 1B exemplifies a first frame 110 of barrel distortion, which extends outward. Referring to FIG. 1A and FIG. 1B, the image capturing module 10 provides the first frame 110, which includes a plurality of first pixels 112 and a base point 114. In the embodiment, the base point 114 corresponds to an optical axis of the image capturing module 10. However, the base point 114 may, for example, be a center point of the first frame 110. In the example that the base point 114 corresponds to the optical axis, the first pixels 112 having the same distance away from the base point 114 as the center point will have the same image magnification. The more distance the first pixel 112 is away from the base point 114, the lesser is its image magnification. Pincushion distortion is another common image distortion, which extends inward. With respect to the pincushion distortion, the more distance the first pixel 112 is away from the base point 114, the greater is its image magnification.

Still referring to FIG. 1A and FIG. 1B, the alteration unit 12 is coupled to receive the first frame 110 and performs a frame resizing step on the first frame 110 along an alteration direction 115. The operating unit 14 performs a compensation step on the first pixels 112 to generate a second frame 111 of a plurality of second pixels 113, such that any two of the adjacent second pixels 113 have the same distance between the adjacent second pixels 113, and a shift operation is executed on the first pixels 112 along a compensation direction 116 based on the base point 114. The storage module 16 may be used to store parameters of the operating unit 14. In the embodiment, the first pixels 112 of the first frame 110 may be raw data, and the second pixels 113 of the second frame 111 may be coding components in a color space such as YUV color space. The alteration unit 12 and the operating unit 14 may, but not necessarily, be integrated in a central processing unit or a digital signal processor.

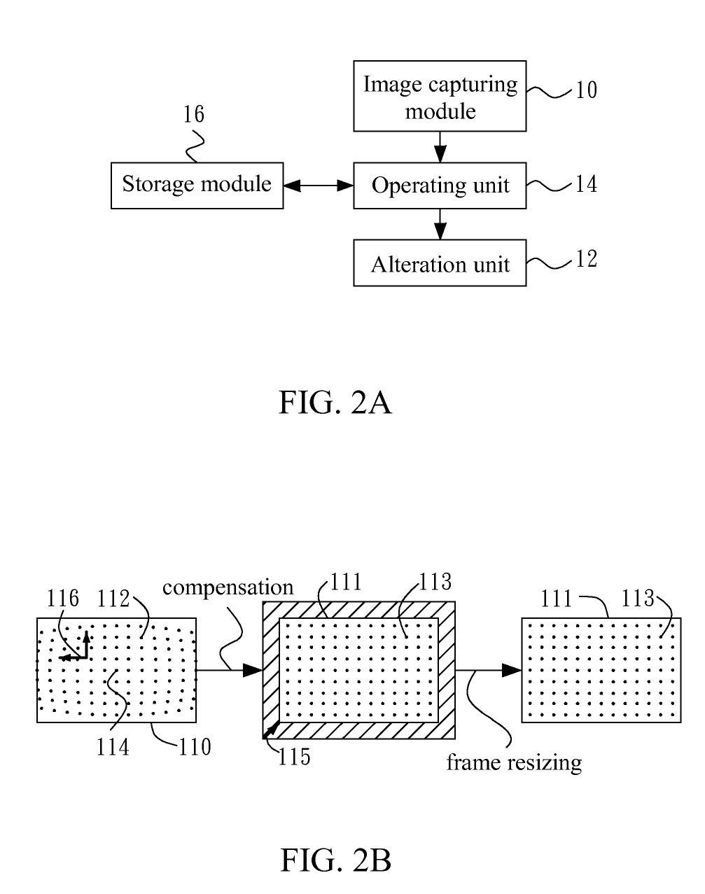

FIG. 2A shows a block diagram of an image compensation system according to another embodiment of the present invention, and FIG. 2B exemplifies the first frame 110 of barrel distortion. Referring to FIG. 2A and FIG. 2B, the distinctness of the present embodiment from the preceding embodiment of FIG. 1A is that, the operating unit 14 of the present embodiment receives the first frame 110 from the image capturing module 10 and performs the compensation step on the first pixels 112 to generate the second frame 111 of the second pixels 113. Subsequently, the alteration unit 12 receives the second frame 111 and performs the frame resizing step on the second frame 111. In the embodiment, a portion of the second pixels 113 may exceed the boundary of the first frame 110 after the compensation step by the operating unit 14. The exceeding second pixels 113 may then be stored in the storage module 16 for later use.

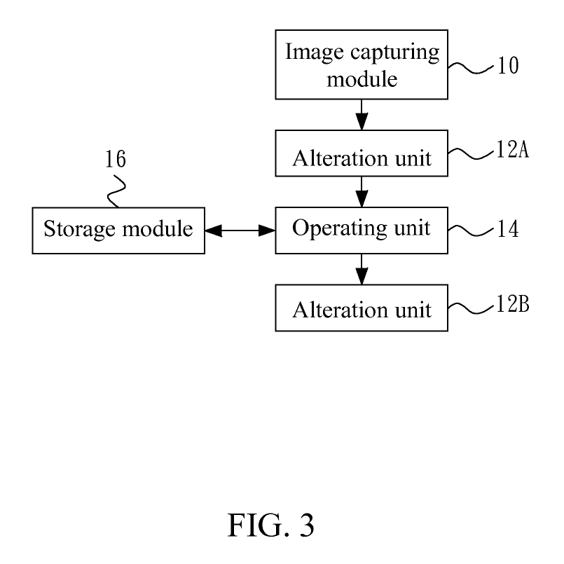

FIG. 3 shows a block diagram of an image compensation system according to a further embodiment of the present invention. The distinctness of the present embodiment from the preceding embodiment of FIG. 1A is that, two alteration units 12A and 12B are used in the present embodiment to perform the frame resizing step on the first pixels 112 and the second pixels 113 respectively, before and after the compensation step by the operating unit 14. Although the alteration unit 12A and the alteration unit 12B are respectively used to perform the frame resizing step on the first pixels 112 and the second pixels 113, it is appreciated that a single alteration unit may be used instead to perform the frame resizing step on the first pixels 112 and the second pixels 113 in sequence.

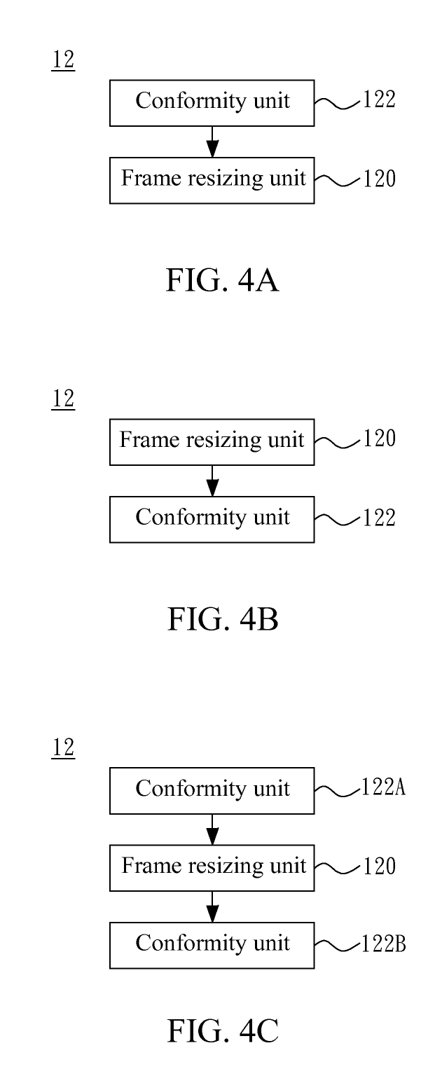

FIG. 4A shows a detailed block diagram of the alteration unit 12. The alteration unit 12 includes a frame resizing unit 120 for performing the frame resizing step, and also includes a conformity unit 122 configured to perform a cutting step before the frame resizing step. With respect to the cutting step, the conformity unit 122 deletes a portion of the first pixels 112 of the first frame 110 or a portion of the second pixels 113 of the second frame 111 along a horizontal direction and/or a vertical direction. FIG. 4B shows another detailed block diagram of the alteration unit 12. The distinctness of FIG. 4B from FIG. 4A is that, the conformity unit 122 of FIG. 4B performs the cutting step after the frame resizing step. FIG. 4C shows a further detailed block diagram of the alteration unit 12. The distinctness of FIG. 4C from FIG. 4A and FIG. 4B is that, two conformity units 122A and 122B of FIG. 4C are used to perform the cutting step before and after the frame resizing step respectively. Although the conformity units 122A and 122B are respectively used to perform the cutting step before and after the frame resizing step respectively, it is appreciated that a single conformity unit 122 may be used instead to perform the cutting step before and after the frame resizing step in sequence.

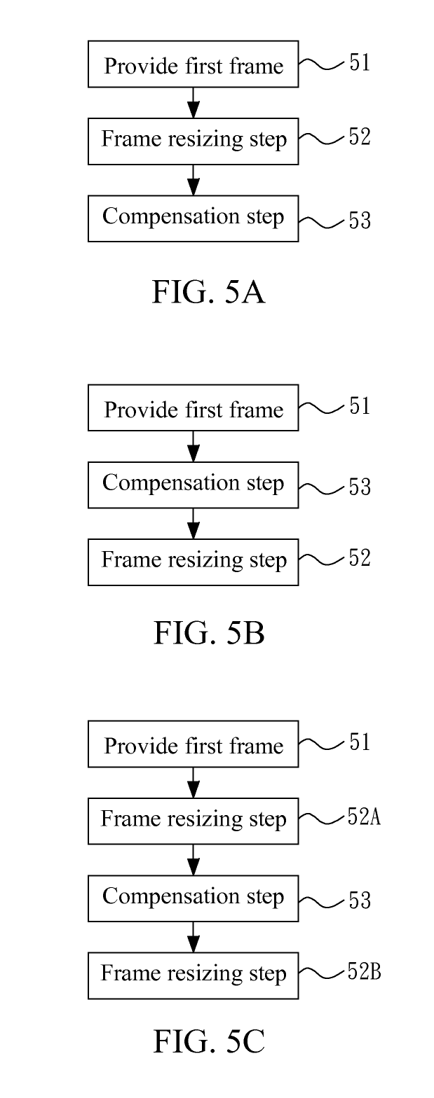

FIG. 5A shows a flow diagram of an image compensation method according to one embodiment of the present invention. Referring to FIG. 5A, FIG. 1A and FIG. 1B, in step 51, the image capturing module 10 provides the first frame 110 of first pixels 112. Subsequently, in step 52, the alteration unit 12 performs the frame resizing step on the first frame 110. In the embodiment, a shift operation associated with the frame resizing step is executed on the first frame 110 along a horizontal direction and/or a vertical direction. In step 53, the compensation, step is performed on the first pixels 112 to generate the second frame 111 of second pixels 113, such that any two of the adjacent second pixels 113 have the same distance between the adjacent second pixels 113. With respect to the compensation step, the shift operation is executed on the first pixels 112 along a compensation direction 116 based on the base point 114. Specifically, the compensation direction 116 directs outward or inward, from the base point 114 in a manner such that any two of the adjacent second pixels 113 have the same distance between the adjacent second pixels 113. Moreover, as shown in FIG. 1B, the compensation direction 116 includes a horizontal X direction and a vertical V direction directing outward from the base point 114. Compared to the conventional four-direction compensation, the computation in the present embodiment can be substantially reduced to accelerate the compensation. Furthermore, the shift operation associated with the compensation step may be executed by interpolation on any two of the adjacent first pixels 112 to generate the second pixels 113.

FIG. 5B shows a flow diagram of an image compensation method according to another embodiment of the present invention. Referring to FIG. 5B, FIG. 2A and FIG. 2B, the distinctness of FIG. 5B from FIG. 5A is that, the compensation step is performed on the first frame 110 before the frame resizing step is performed on the second frame 111. As shown in FIG. 2B, a portion, of the second pixels 113 may exceed the boundary of the first frame 110, and the exceeding second pixels 113 may be stored in the storage area provided, by the storage module 16 for later use.

FIG. 5C shows a flow diagram of an image compensation method according to a further embodiment of the present invention. Referring to FIG. 5C and FIG. 3, the distinctness of FIG. 5C from FIG. 5A and FIG. 5B is that, two frame resizing steps 52A and 52B are performed before and after the compensation step 53 respectively. One of the frame resizing steps may be performed by executing the shift operation on the first pixels 112 along a horizontal direction, and another of the frame resizing steps may be performed by executing the shift operation on the second pixels 113 along a vertical direction. In other words, the frame resizing step may be performed on the first pixels 112 along the horizontal direction, followed by the compensation step 53, after which the frame resizing step may further be performed along the vertical direction. Alternatively, the frame resizing step may be performed along the vertical direction, followed by the compensation step 53, after which the frame resizing step may further be performed along the horizontal direction.

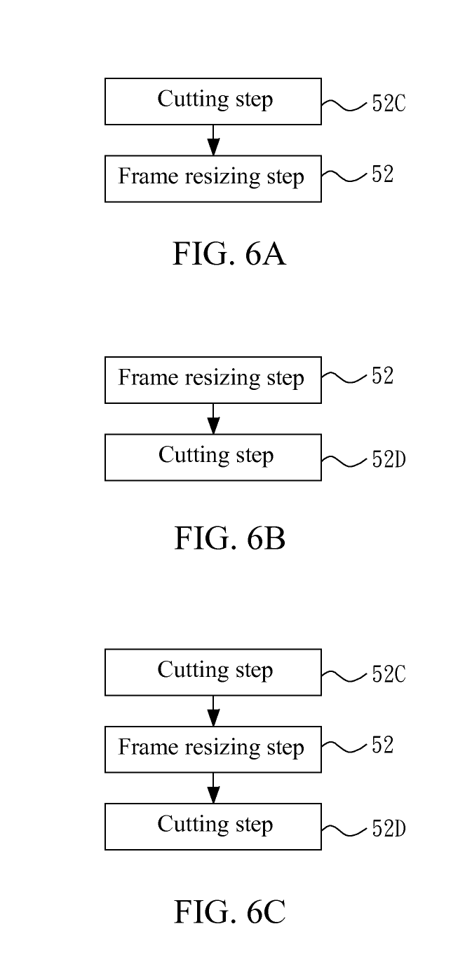

FIG. 6A shows a cutting step 52C performed before the frame resizing step 52. The cutting step 52C deletes a portion of the first pixels 112 of the first frame 110 or a portion of the second pixels 113 of the second frame 111 along a horizontal direction and/or a vertical direction. FIG. 6B shows a cutting step 52D performed after the frame resizing step 52. FIG. 6C shows two cutting steps 52C and 52D performed respectively before and after the frame resizing step 52.

The compensation step discussed above may be implemented by a variety of interpolation methods. After the compensation step, the number of pixels may be increased or decreased. Specifically, the interpolation is executed on at least two adjacent pixels, and the interpolated pixel is newly added between the two adjacent pixels, thereby increasing the number of pixels. Alternatively, averaging is executed on at least two adjacent pixels to obtain an interpolated value, which is used to replace a portion of the adjacent pixels, thereby decreasing the number of pixels.

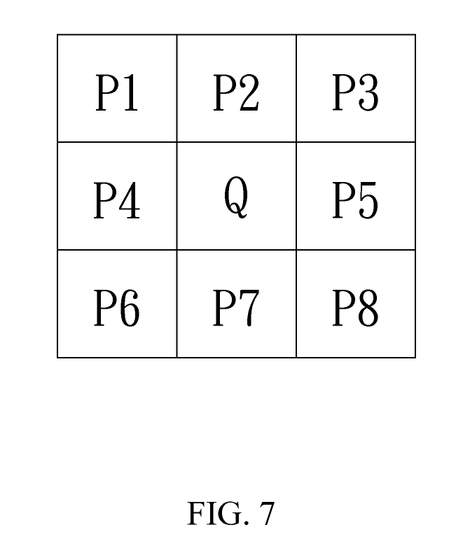

FIG. 7 shows raw pixels P1-P8 and an interpolated pixel Q. In one example, a bi-linear interpolation, is operated on the raw pixels P1, P3, P6 and P8 to obtain the interpolated pixel Q. It is noted that the interpolated pixel Q is not necessarily at the center among the raw pixels P1, P3, P6 and P8. The bi-linear interpolation mentioned above is one of non-adaptive image interpolation methods. However, an adaptive image interpolation method, such as edge detection interpolation, may be used instead. For example, as shown in FIG. 7, when a horizontal gradient, e.g., absolute difference between P4 and P5, is less than a threshold value, and a vertical gradient, e.g., absolute difference between P2 and P7, is greater than a threshold value, indicating that an image edge exists along the horizontal direction, an average value between the raw pixels P4 and P5 may thus be obtained as the interpolated pixel Q, that is, Q=(P4+P5)/2.

Referring to FIG. 1B and FIG. 2B, the frame resizing step discussed above may be performed by applying the same image magnification on each pixel with respect to the base point 114 along the horizontal direction, thereby resizing the width of the frame. Alternatively, the frame resizing step may be performed by applying the same image magnification on each pixel with respect to the base point 114 along the vertical direction, thereby resizing the height of the frame. Alternatively, the frame resizing step may be performed by applying the same image magnification on each pixel with respect to the base point 114 along the horizontal direction and vertical direction, thereby resizing the entire size of the frame.

Although specific embodiments have been illustrated and described, it will be appreciated by those skilled in the art that various modifications may be made without departing from the scope of the present invention, which is intended to be limited solely by the appended claims.

What is claimed is:

1. An image compensation method, comprising:
providing a first frame of a plurality of first pixels; and
performing a compensation step on the first pixels to generate a second frame of a plurality of second pixels, wherein any two of the adjacent second pixels have a same distance therebetween;
wherein a frame resizing step is performed before and/or after the compensation step.

2. The method of claim 1, wherein the first frame further comprises a base point, based on which the compensation step is performed along a compensation direction to execute a shift operation on the first pixels.

3. The method of claim 2, wherein the compensation direction radiates outward or inward from the base point.

4. The method of claim 3, wherein the shift operation is executed by interpolation on any two of the adjacent first pixels, thereby generating the second pixels.

5. The method of claim 3, further comprising:
providing a storage area for storing the second pixels that exceed a boundary of the first frame after the compensation step.

6. The method of claim 2, wherein the frame resizing step performed before the compensation step to execute the shift operation on the first pixels along a horizontal direction or a vertical direction.

7. The method of claim 2, wherein the frame resizing step is performed after the compensation step to execute the shift operation on the second pixels along a horizontal direction or a vertical direction.

8. The method of claim 2, wherein the frame resizing step is performed before and after the compensation step to execute the shift operation on the first pixels and the second pixels respectively along a horizontal direction or a vertical direction.

9. The method of claim 1, further comprising performing a cutting step before and/or after the frame resizing step.

10. The method of claim 9, wherein the cutting step comprises deleting a portion of the first pixels or the second pixels.

11. The method of claim 1, wherein the first pixels are raw data, and the second pixels are coding components in a color space.

12. An image compensation system, comprising:
an image capturing module configured to provide a first frame having a plurality of first pixels and a base point;
an operating unit configured to perform a compensation step on the first pixels to generate a second frame of a plurality of second pixels, wherein any two of the adjacent second pixels have a same distance therebetween, and a shift operation is executed on the first pixels along a compensation direction based on the base point; and
an alteration unit configured to perform a frame resizing step before and/or after the compensation step.

13. The system of claim 12, wherein the compensation direction radiates outward or inward from the base point.

14. The system of claim 13, wherein the compensation step is performed by interpolation on the adjacent first pixels, thereby generating the second pixels.

15. The system of claim 13, further comprising:
a storage module configured to store the second pixels that exceed a boundary of the first frame after the compensation step.

16. The system of claim 12, wherein the frame resizing step is performed before or after the compensation step to execute the shift operation on the first pixels or the second pixels respectively along a horizontal direction or a vertical direction.

17. The system of claim 12, wherein the frame resizing step is performed before and after the compensation step to execute the shift operation on the first pixels and the second pixels respectively along a horizontal direction or a vertical direction.

18. The system of claim 12, further comprising a conformity unit configured to perform a cutting step before and/or after the frame resizing step.

19. The system of claim 18, wherein the cutting step comprises deleting a portion of the first pixels of the first frame or the second pixels of the second frame along a horizontal direction and/or a vertical direction.

20. The system of claim 12, wherein the first pixels are raw data, and the second pixels are coding components in a color space.
